(19) United States
(12) Patent Application Publication
(10) Pub. No.: US 2020/0177763 A1
(43) Pub. Date: Jun. 4, 2020

(54) Image Reading Apparatus

(71) Applicant: Konica Minolta, Inc., Tokyo (JP)

(72) Inventor: Hiroaki KUBO, Muko-shi (JP)

(73) Assignee: Konica Minolta, Inc., Tokyo (JP)

(21) Appl. No.: 16/697,400

(22) Filed: Nov. 27, 2019

(30) Foreign Application Priority Data
Nov. 30, 2018 (JP) 2018-225907

(51) Int. Cl. H04N 1/393; H04N 1/00

(52) U.S. Cl. CPC H04N 1/393; H04N 2201/0094; H04N 2201/0081; H04N 1/00238

(57) ABSTRACT

Disclosed is an image reading apparatus that may include a scan data acquirer that acquires scan data obtained by reading from printed matter output by an image forming apparatus, a magnification acquirer that acquires a magnification used when the printed matter is imaged, a reverse scaling part that generates reverse-scaled data obtained by scaling the scan data at a reverse magnification that is the reciprocal of the magnification acquired by the magnification acquirer, and a determiner that determines whether a predetermined reference image is included in the reverse-scaled data by comparing with the predetermined reference image.

### CROSS REFERENCE TO RELATED APPLICATIONS

This application claims priority to Japanese Patent Application No. 2018-225907, filed on Nov. 30, 2018, which is incorporated herein by reference in its entirety.

### BACKGROUND

### Technological Field

The present disclosure relates to an image reading apparatus, and more particularly to a technique for reducing a processing load for detecting an image for which image formation is prohibited.

### Description of the Related Art

Conventionally, in order to manage the quality of printed matter output from an image forming apparatus, a reading apparatus that checks print quality using scan data obtained by reading a printing part has been used. When the reading apparatus detects printed matter that may have a problem with print quality, the reading apparatus notifies the user to that effect. The user who receives the notification refers to scan data stored in the reading apparatus to check whether there is a problem with the print quality, and if there is a problem, check what kind the problem is. As a result, the user can redo the printing, or identify and eliminate the cause so that no problem occurs in the print quality of the subsequent printed matter.

Incidentally, some printed matter output by the image forming apparatus should be managed so that they cannot be viewed or copied without permission.

To deal with such a problem, a technique has been proposed (see JP 2014-113775 A, for example) in which it is checked whether scan data includes a specific mark (image as indicator) or a pattern every time printed matter is read, and if the mark or pattern is included, the printed matter is crushed, marked to prevent use, or discharged to a dedicated tray, for example. According to this conventional technique, it is possible to prevent direct output of printed matter whose viewing and copying should be restricted.

Additionally, an image forming apparatus has multiple types of pattern data of images of special copies such as banknotes registered in advance. In a case where an input image is enlarged or reduced, the image forming apparatus performs reverse scaling processing for restoring one-to-one magnification, compares the image restored to one-to-one magnification with the pattern data of each registered special original, and determines whether or not the image is an image of a special original. There has also been proposed a technique for performing anti-counterfeit processing such as not adding color to an output image when it is determined that the image is an image of a special original (see JP 2000-232578 A).

However, an image forming apparatus has a scaling function for enlarging or reducing an image, and the above-mentioned specific mark or pattern is also scaled in scaled printed matter. Hence, output of printed matter cannot be managed sufficiently only by detecting a mark or pattern of one-to-one magnification.

Additionally, in view of such problems, it is conceivable to prepare marks or patterns with various magnifications and detect whether such marks or patterns are included in a round-robin manner. However, when there are many types of marks or patterns to be detected, the detection processing takes too much time and it becomes impossible to follow the output speed of the image forming apparatus, or the productivity of the image forming apparatus has to be reduced, and therefore the method is not realistic.

Additionally, the latter of the above two conventional techniques relates to prevention of counterfeit when an original is set and read on a copying machine or the like and the original is scaled at a specified magnification. If the input image is enlarged or reduced, reverse scaling processing is performed to restore one-to-one magnification.

Since the magnification at this time is specified by the image forming apparatus, it is possible to specify the magnification to be used. However, when a sheet once discharged from the image forming apparatus is read by a reading apparatus that checks print quality, the reading apparatus does not edit the image data, nor parameters for editing (including magnification) are specified. Hence, when a sheet including an enlarged or reduced prohibited image is discharged, it cannot be determined whether the image is a prohibited image by using pattern data of one-to-one magnification.

### SUMMARY

The present disclosure has been made in view of the above-described problems, and aims to provide an image reading apparatus capable of efficiently detecting a reference image that may be included in printed matter output from an image forming apparatus.

To achieve the abovementioned object, according to an aspect of the present disclosure, an image reading apparatus reflecting one aspect of the present disclosure may comprise a scan data acquirer that acquires scan data obtained by reading from printed matter output by an image forming apparatus, a magnification acquirer that acquires a magnification used when the printed matter is imaged, a reverse scaling part that generates reverse-scaled data obtained by scaling the scan data at a reverse magnification that is the reciprocal of the magnification acquired by the magnification acquirer, and a determiner that determines whether or not a predetermined reference image is included in the reverse-scaled data by comparing with the predetermined reference image.

### BRIEF DESCRIPTION OF THE DRAWINGS

The advantages and features provided by one or more embodiments of the disclosure will become more fully understood from the detailed description given hereinbelow and the appended drawings which are given by way of illustration only, and thus are not intended as a definition of the limits of the present disclosure:

FIG. 1 is a diagram showing a main configuration of a multi-function peripheral according to an embodiment of the present disclosure;

FIG. 2 is a block diagram showing main hardware configurations of a read controller and a printer controller;

FIG. 3 is a block diagram showing main functional configurations of the read controller and the printer controller;

FIG. 4 is a flowchart showing an operation of the printer controller;

FIG. 5 is a flowchart showing an operation of the read controller;

FIG. 6A is a diagram showing a flow of print processing, and FIG. 6B is a table for describing a relationship between the form of reference images and detection processing;

FIG. 7 is a flowchart for describing a modification in which a reference image is detected every time one band of printed matter is read;

FIG. 8 is a diagram showing a configuration of a reading apparatus according to a modification of the present disclosure;

FIG. 9 is a flowchart for describing an operation of a read controller according to a modification of the present disclosure; and

FIG. 10 is a flowchart for describing an operation of a read controller according to a modification of the present disclosure.

### DETAILED DESCRIPTION OF EMBODIMENTS

Hereinafter, one or more embodiments of an image reading apparatus according to the present disclosure will be described with reference to the drawings, taking a multi-function peripheral (MFP) as an example. However, the scope of the disclosure is not limited to the disclosed embodiments.

### [1] CONFIGURATION OF MFP

First, a configuration of the MFP according to the embodiment will be described.

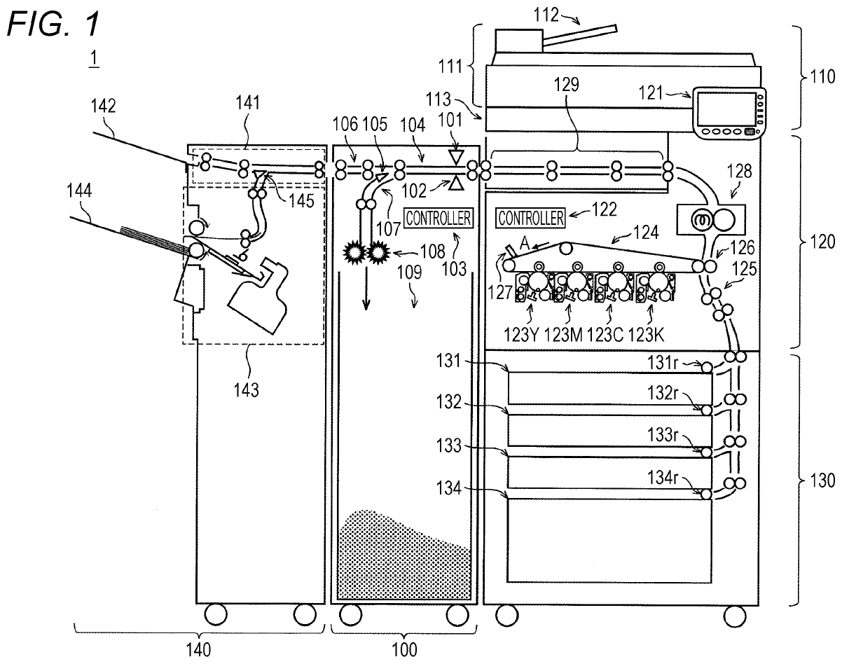

As shown in FIG. 1, an MFP 1 includes a reading apparatus 100, a scanner 110, a printer 120, a sheet feeder 130, and a finisher 140, and performs functions such as a printer function, a scanner function, a copy function, a facsimile function, and a document server function.

When the scanner 110 receives an original reading instruction from the user through an operation panel 121 included in the printer 120, the scanner 110 uses an automatic document feeder (ADF) 111 to convey originals one by one to an image reading portion 113 from a bundle of originals placed on an original tray 112, and uses the image reading portion 113 to read the originals and generate image data.

The printer 120 is a so-called tandem color printer. When a print job is received by a controller (hereinafter referred to as “printer controller”) 122, in a case of forming a color image, toner images of each color of YMCK are formed by using image forming portions 123Y, 123M, 123C, and 123K, and the toner images are electrostatically transferred (primary transfer) onto an intermediate transfer belt 124 so that the toner images overlap one another, thereby forming a color toner image. In a case of forming a monochrome image, a K-color toner image is formed by using only the image forming portion 123K, and the toner image is electrostatically transferred (primary transfer) onto the intermediate transfer belt 124.

The intermediate transfer belt 124 rotates in the direction of arrow A to convey the toner image to a secondary transfer roller pair 126.

The sheet feeder 130 feeds recording sheets stored in feeding trays 131, 132, 133, and 134 one by one by using pickup rollers 131r, 132r, 133r, and 134r. The fed recording sheet is conveyed by a conveyance roller, gets its skew corrected and conveyance timing adjusted by a timing roller 125, and is then conveyed to the secondary transfer roller pair 126.

A secondary transfer bias voltage is applied to the secondary transfer roller pair 126, whereby the toner image on the intermediate transfer belt 124 is electrostatically transferred (secondary transfer) to the recording sheet. The toner remaining on the intermediate transfer belt 124 after the secondary transfer is scraped off by a cleaning blade 127 and discarded. After the toner image is thermally fixed onto the recording sheet by a fixing portion 128, the recording sheet is conveyed toward the reading apparatus 100 through a conveyance path 129.

When receiving the recording sheet from a conveyor 129, the reading apparatus 100 reads front and back surfaces of the recording sheet using line scanners 101 and 102, and generates color image data. A controller (hereinafter referred to as “read controller”) 103 controls the posture of a path switching claw 105 depending on whether or not a prestored reference image is included in the image data.

When the recording sheet that passed through the conveyance path 104 includes a reference image, the recording sheet is guided to a conveyance path 107 by the path switching claw 105, cut by a cutting roller 108, and is then stored in a cutting waste container 109. On the other hand, when a reference image is not included, the recording sheet is guided to a conveyance path 106 by the path switching claw 105 and is output to the finisher 140.

The finisher 140 controls the posture of a path switching claw 145 depending on whether or not post-processing is instructed in the print job. When post-processing is not instructed, the recording sheet is guided to a discharge tray 142 by the path switching claw 145 through a conveyance path 141. Meanwhile, when post-processing is instructed, the path switching claw 145 guides the recording sheet to a post-processing device 143.

The post-processing device 143 performs post-processing such as alignment of the recording sheet bundle, punching, stapling, and folding on the recording sheet in accordance with instructions in the print job. The post-processed recording sheet is discharged onto a discharge tray 144.

### [2] HARDWARE CONFIGURATION OF READ CONTROLLER 103 AND PRINTER CONTROLLER 122

Next, hardware configurations of the read controller 103 and the printer controller 122 will be described.

(2-1) Hardware Configuration of Printer Controller 122

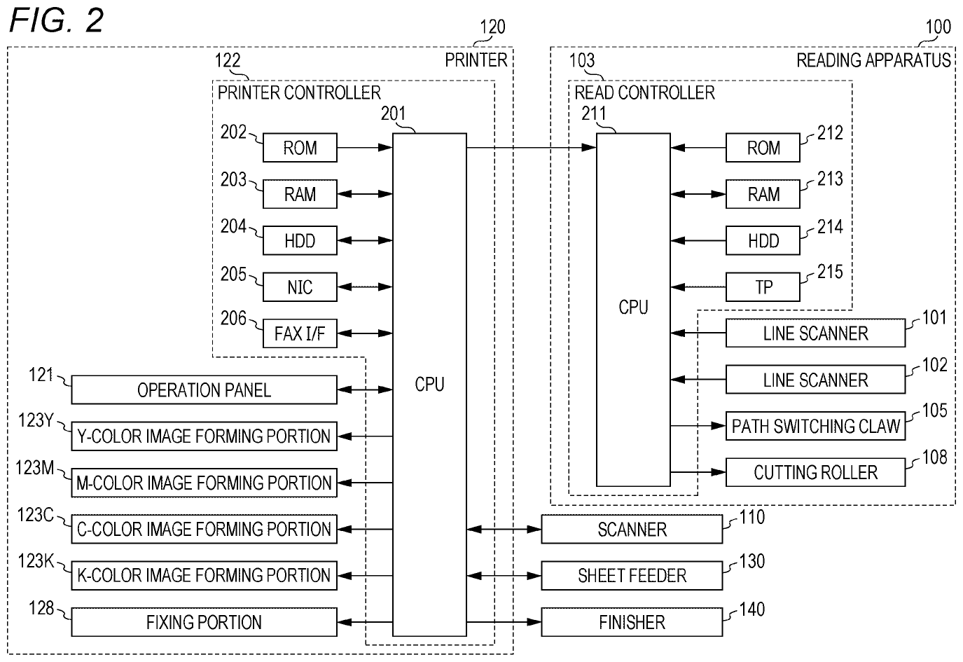

As shown in FIG. 2, the printer controller 122 includes a central processing unit (CPU) 201, a read only memory (ROM) 202, a random access memory (RAM) 203, and the like. When the MFP 1 is powered on, the CPU 201 reads and activates a boot program from the ROM 202, and executes an operating system (OS) and a control program read from a hard disk drive (HDD) 204 using the RAM 203 as a working storage area.

A network interface card (NIC) 205 performs communication processing when accepting print jobs from other devices or transmitting image data to other devices through a communication network such as a local area network (LAN). A FAX interface 206 exchanges facsimile data with other facsimile devices through a facsimile line.

By controlling the operation of the operation panel 121, the printer controller 122 presents information to the user of the MFP 1 and receives instructions from the user. The instructions include generation of image data by reading an original, copying using the image data, facsimile transmission using the image data, execution of a print job received from another device, and printed output of facsimile data received from another facsimile device, for example.

When forming an image, the printer controller 122 controls the image forming portions 123Y, 123M, 123C, and 123K to form toner images of each color of YMCK, and controls the fixing temperature of the fixing portion 128 to thermally fix the toner image on the recording sheet, for example. Similarly, the printer controller 122 controls the scanner 110 to read an original to generate image data, or controls the sheet feeder 130 to feed a recording sheet specified by a print job or specified by the user using the operation panel 121.

(2-2) Hardware Configuration of Read Controller 103

Similar to the printer controller 122, the read controller 103 includes a central processing unit (CPU) 211, a read only memory (ROM) 212, a random access memory (RAM) 213, and the like. When the MFP 1 is powered on, the CPU 211 reads and activates a boot program from the ROM 212, and executes an operating system (OS) and a control program read from a hard disk drive (HDD) 214 using the RAM 213 as a working storage area.

As a result, the CPU 211 generates image data from the line-by-line image data output by the line scanners 101 and 102 reading the original, determines the presence or absence of a reference image, and controls the posture of the path switching claw 105 or controls the cutting roller 108 depending on the determination result.

Additionally, the read controller 103 includes a touch panel (TP) 215, and can present information to the user of the MFP 1 or accept an instruction input from the user.

### [3] FUNCTIONAL CONFIGURATION OF READ CONTROLLER 103 AND PRINTER CONTROLLER 122

Next, functional configurations of the read controller 103 and the printer controller 122 will be described.

(3-1) Functional Configuration of Printer Controller 122

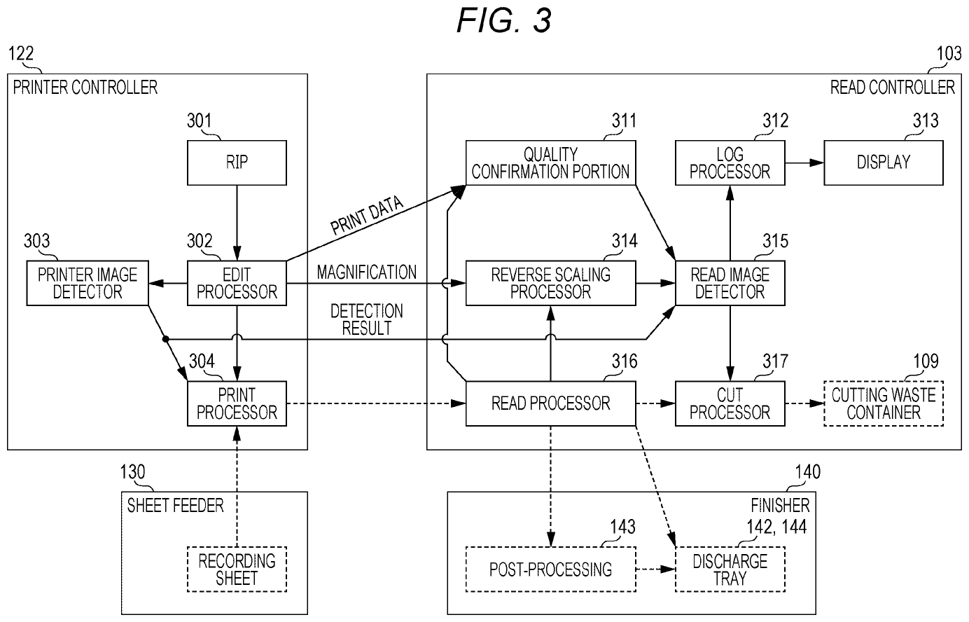

As shown in FIG. 3, the printer controller 122 includes a raster image processor (RIP: hereinafter referred to as “RIP”) 301, an edit processor 302, a printer image detector 303, and a print processor 304. These functions are implemented by the CPU 201 executing the control program.

The RIP 301 generates raster image data (hereinafter referred to as “RIP data”) by performing rasterization processing on image data specified by the print job. A print job is described using a page description language such as Postscript, portable document format (PDF), or XML, paper specification (XML: Extensible Markup Language) (XPS). Additionally, RIP data is bitmap data.

The edit processor 302 generates image data (hereinafter referred to as “print data”) obtained by editing RIP data generated by the RIP 301. In particular, when a magnification is specified in a print job, the RIP data is scaled by the magnification. Note that in a print job, there are a case where a magnification is specified by a numerical value and a case where a magnification is specified by specifying a layout such as 2 in 1.

The edit processor 302 transmits a magnification and print data in response to a request from the read controller 103. The embodiment describes a case of transmitting a numerical value representing a magnification to the read controller 103 as an example, regardless of whether or not a magnification is specified using a numerical value in a print job. However, it goes without saying that the magnification may be displayed using data other than a numerical value.

The printer image detector 303 detects whether or not a reference image is included in print data. In the embodiment, a reference image refers to an image printed to specify the authenticity of securities on vouchers whose copying is prohibited, such as banknotes or securities, or a mark provided on a document containing secret that needs to be kept from being leaked. An example of such a mark or pattern is a mark or pattern including a character string such as “for internal use only” or “CONFIDENTIAL”.

The printer image detector 303 prestores the reference image as described above, and compares the reference image with the print data for each reference image to detect whether the reference image is included in the print data. The printer image detector 303 transmits a detection result in response to a request from the read controller 103. Additionally, the printer image detector 303 notifies the print processor 304 of the detection result.

The print processor 304 forms an image on a recording sheet supplied by the sheet feeder 130 using the print data generated by the edit processor 302. Note that when the printer image detector 303 provides notification of a detection result that reference image is included in the print data, image formation is not performed. Additionally, in FIG. 3, broken arrows indicate the flow of recording sheets and printed matter.

(3-2) Functional Configuration of Read Controller 103

The read controller 103 includes a quality confirmation portion 311, a log processor 312, a display 313, and the like. These functions are implemented by the CPU 211 executing the control program.

A read processor 316 controls the line scanners 101 and 102 to read printed matter output from the printer 120 and generate image data (hereinafter referred to as “scan data”).

A reverse scaling processor 314 acquires a magnification M of print data corresponding to the scan data from the edit processor 302 of the printer controller 122, and generates image data (hereinafter referred to as “reverse-scaled data”) by reverse scaling scan data stored in an image storage unit 314. Here, reverse scaling refers to processing for scaling scan data with a magnification that is the reciprocal (1/M) of the magnification M acquired from the edit processor 302.

A read image detector 315 detects whether or not a reference image is included in image data by sequentially comparing prestored reference images with the image data. The image data is print data, scan data, and reverse-scaled data. Note that in the embodiment, the read image detector 315 stores the same reference images as those stored in the printer image detector 303.

The quality confirmation portion 311 acquires print data from the edit processor 302, compares the print data with scan data, and determines whether or not the print data and the scan data match. If the print data and the scan data do not match, it can be estimated that there is a problem with print quality, such as the printed matter being torn.

The log processor 312 creates an image log and a display screen nail image for each piece of printed matter. An image log includes a quality confirmation result by the quality confirmation portion 311, a detection result by the read image detector 315, and scan data. Additionally, a display screen nail image is a thumbnail image obtained by reducing the image log.

The display 313 displays a list of display nail images generated by the log processor 312 on the touch panel 215. When the user of the MFP 1 touches one of the display screen nail images, an image log corresponding to the display screen nail image is displayed on the touch panel 215.

The cut processor 317 controls the posture of the path switching claw 105, guides printed matter to the cutting roller 108, cuts the printed matter, and discards the cutting waste into the cutting waste container 109. When cutting is not performed, the cut processor 317 controls the posture of the path switching claw 105 and guides the printed matter to the finisher 140. When post-processing is specified in the print job, the printed matter is post-processed by the post-processing device 143, and is then discharged to the discharge tray 144. When post-processing is not performed, the printed matter is discharged directly to the discharge tray 142.

### [4] OPERATION OF CONTROLLERS 103 AND 122

Next, operations of the controllers 103 and 122 will be described.

(4-1) Operation of Printer Controller 122

First, an operation of the printer controller 122 will be described.

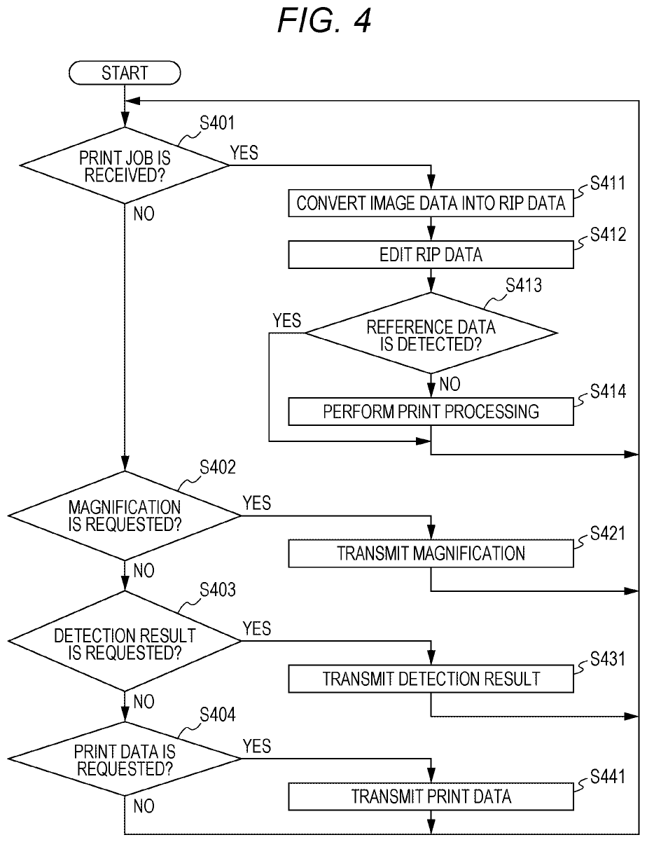

As shown in FIG. 4, when a print job is received (S401: YES), the printer controller 122 controls the RIP 301 to generate RIP data from image data included in the print job (S411), and controls the edit processor 302 to edit the RIP data to generate print data (S412). If the printer image detector 303 does not detect that the reference image is included in the print data (S413: NO), an image is formed using the print data (S414).

If the reverse scaling processor 314 of the read controller 103 requests a magnification that the edit processor 302 used to generate print data (S402: YES), the edit processor 302 transmits the magnification to the reverse scaling processor 314 (S421).

If the reverse scaling processor 314, the log processor 312, and the cut processor 317 of the read controller 103 request a detection result by the printer image detector 303 (S403: YES), the printer image detector 303 transmits the detection result to the reverse scaling processor 314, the log processor 312, or the cut processor 317 that is the request source (S431).

If the quality confirmation portion 311 of the read controller 103 requests print data (S404: YES), the edit processor 302 transmits the print data to the quality confirmation portion 311 (S441).

(4-2) Operation of Read Controller 103

Next, an operation of the read controller 103 will be described.

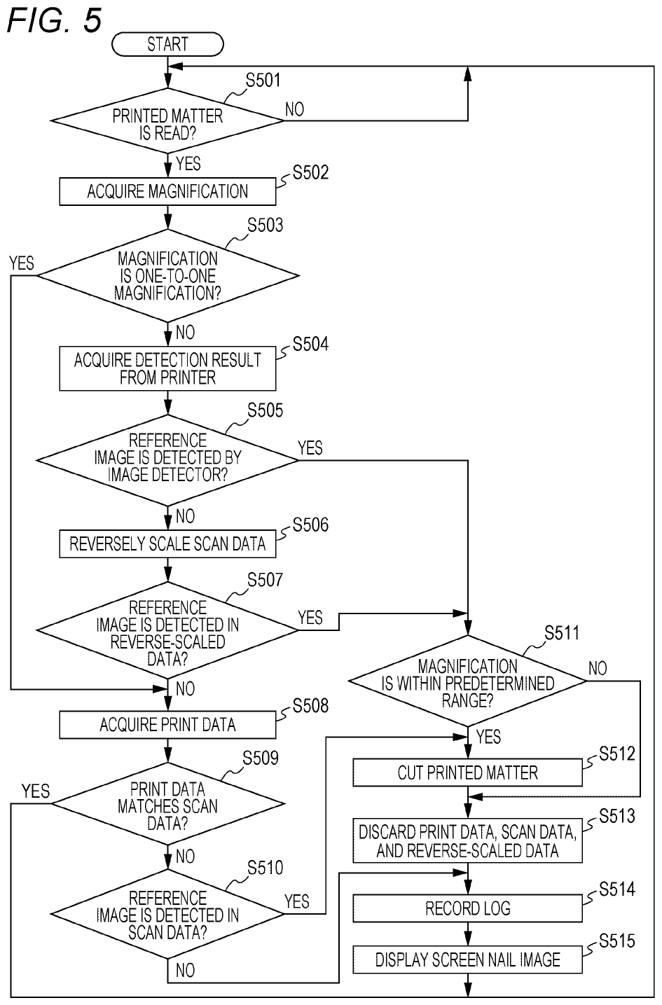

As shown in FIG. 5, when the read controller 103 controls the read processor 316 to read printed matter and generate scan data (S501: YES), the controller 103 controls the reverse scaling processor 314 to acquire a magnification from the edit processor 302 of the printer controller 122 (S502), and if the acquired magnification is one-to-one magnification (S503: YES), the processing proceeds to step S508. If the acquired magnification is not one-to-one magnification (S503: NO), the read image detector 315 acquires the detection result by the printer image detector 303 (S504).

If the detection result by the printer image detector 303 is positive, in other words, if the printer image detector 303 determines that the reference image is included in the print data (S505: YES), the processing proceeds to step S511. If the detection result by the printer image detector 303 is negative (S505: NO), the reverse scaling processor 314 reversely scales the scan data to generate reverse-scaled data (S506), and the read image detector 315 determines whether or not a reference image is included in the reverse-scaled data.

If the detection result by the read image detector 315 is affirmative, in other words, if the reference image is included in the reverse-scaled data (S507: YES), the processing proceeds to step S511. In step S511, the read image detector 315 determines whether or not the magnification by the edit processor 302 is within a predetermined range. While the predetermined range is 95% to 105% In the embodiment, it may be a different range, as long as it is a range including one-to-one magnification (100%).

If the magnification is within the predetermined range (S511: YES), the printed matter is cut by the cut processor 317 (S512) and discarded in the cutting waste container 109. For example, if the print data is a banknote image and is close to the original size (one-to-one magnification), it may be mistaken as a banknote, and therefore may be misused as a fake bill. Hence, such misuse can be prevented by cutting the printed matter when the magnification is close to one-to-one magnification.

After the processing of step S512 and if the magnification is out of the predetermined range (S511: NO), the print data, the scan data, and the reverse-scaled data are discarded (S513). Since this can prevent copying of printed matter using these types of data, it is possible to prevent unauthorized copying of printed matter whose copying is prohibited such as banknotes, and prevent leakage of confidential information by copying a document.

Thereafter, the log processor 312 generates an image log and a display nail image, records the image log (S514), the display 313 displays the display screen nail image on the touch panel 215 (S514), and the processing proceeds to step S501, to repeat the above processing. Note that when scan data is discarded, the log processor 312 generates an image log that does not include the scan data. It goes without saying that the display screen nail image generated from the image log not including the scan data does not include the scan data either.

If the reference image is not included in the reverse-scaled data (S507: NO), the quality confirmation portion 311 acquires print data from the edit processor 302 of the printer controller 122 (S508), and checks whether the acquired print data matches the scan data. If they match (S509: YES), it is considered that there is no problem with the quality of the printed matter, so the processing proceeds to step S501 to repeat the above processing.

If the print data does not match the scan data (S509: NO), the read image detector 315 detects whether or not a reference image is included in the scan data. If the reference image is included in the scan data (S510: YES), the printed matter is cut by the cut processor 317 (S512), discarded in the cutting waste container 109, and the processing proceeds to step S513.

If the reference image is not included in the scan image (S510: NO), the log processor 312 generates an image log and a display screen nail image, and records the image log (S514). The display 313 displays the display screen nail image on the touch panel 215 (S514), and the processing proceeds to step S501 to repeat the above processing.

### [5] EFFECT

The effect of the embodiment will be described.

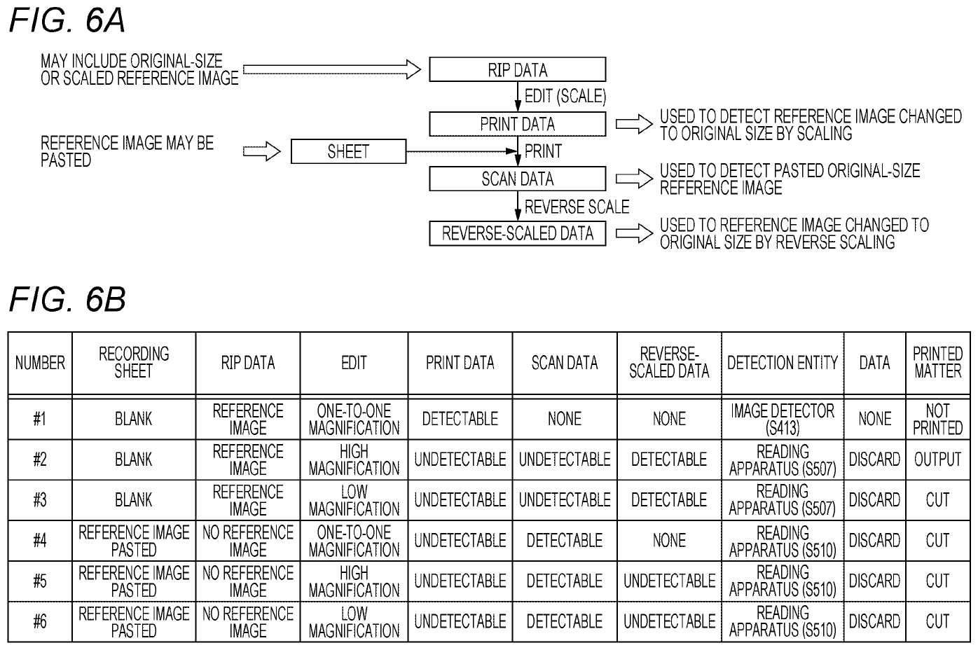

As shown in FIG. 6A, RIP data generated from a print job may include an original-size or scaled reference image. By comparing print data generated by editing the RIP data with the original-size reference image by the printer image detector 303, it is possible to detect a prohibited image such as a banknote printed in the original size (case #1 of FIG. 6B).

Additionally, when printing is performed by pasting a prohibited image on a recording sheet, even if the print data itself does not include the prohibited image, the reading apparatus 100 could generate and store scan data including the original-size prohibited image. In this case, by comparing the scan data with the original-size reference image by the read image detector 315, it is possible to determine the presence or absence of the prohibited image (cases #4, #5, and #6 of FIG. 6B).

Further, by acquiring a magnification from the edit processor 302, generating reverse-scaled data from scan data, and comparing the reverse-scaled data with an original-size reference image, it is possible to determine the presence or absence of a prohibited image even with printed data obtained by scaling RIP data including the original-size reference image (cases #2 and #3 of FIG. 6B).

Accordingly, since it is possible to determine the presence or absence of a prohibited image using only the original-size reference image, as compared to a case of preparing reference images with various magnifications other than the original size in consideration of the magnification and comparing them sequentially with image data, the processing load on the read controller 103 required for detection of a prohibited image can be reduced, and processing time can be shortened.

Additionally, when the magnification is within a predetermined range including one-to-one magnification, the printed matter could be mistaken as printed matter including an original-size prohibited image, and it is hard to distinguish between the two. Hence, there is a high risk of unauthorized use. In view of such a problem, since printed matter whose magnification is within the predetermined range is discarded, it is possible to prevent unauthorized use of printed matter including an original-size prohibited image and printed matter including a prohibited image that could be mistaken as the original size (case #3 of FIG. 6B).

On the other hand, if the magnification is out of the predetermined range, the size is obviously different from the original-size prohibited image, so there is no possibility of being confused with the original-size prohibited image or being misused. Hence, printout is performed in consideration of user convenience (case #2 of FIG. 6B).

Additionally, if the magnification is one-to-one magnification, the printer image detector 303 can detect the prohibited image using the original-size reference image. Hence, there is no need for the read image detector 315 to detect the prohibited image again. For this reason, by performing conditional branching as in step S503 of FIG. 5, the processing load on the read controller 103 can be reduced by omitting the processing in the read image detector 315 (case #1 of FIG. 6B).

Additionally, since printed matter on which the prohibited image is printed is processed to be unusable by cutting the printed matter by the cut processor 317, the printed matter cannot be output to the outside of the reading apparatus 100. Thus, unauthorized use of printed matter on which a prohibited image is printed can be surely prevented (cases #3 to #6 of FIG. 6B).

Additionally, when a prohibited image is pasted to a recording sheet, since the prohibited image is not included in the print data, the prohibited image cannot be detected by the printer image detector 303. Additionally, when the magnification of the edit processor 302 is one-to-one magnification, the detection processing by the read image detector 315 is not performed.

Further, when the magnification by the edit processor 302 is not one-to-one magnification, reverse-scaled data is generated by reverse scaling scan data including an original-size prohibited image. Hence, the prohibited image included in the reverse-scaled data is not of original size. Accordingly, since the reference image included in the prohibited image is not the original size either, the read image detector 315 cannot detect the prohibited image using the original-size reference image. In view of such a problem, in the embodiment, if the scan data does not match the print data (S509: NO), there is a possibility that a prohibited image is pasted to the recording sheet.

In this case, focusing on to the fact that the prohibited image included in the scan data is of the original size, the read image detector 315 detects the prohibited image using the original-size reference image. Accordingly, even when a prohibited image is pasted to a recording sheet, it is possible to detect the prohibited image and discard the printed matter and the scan data. In this case, too, since only the original-size reference image needs to be used, the processing load on the read controller 103 can be reduced.

### [6] MODIFICATION

While the present disclosure has been described on the basis of the embodiment, it is needless to say that the disclosure is not limited to the above-mentioned embodiment, and the following modifications can be implemented.

(6-1) While the above embodiment describes a case where the processing proceeds to step S502 of FIG. 5 after the read processor 316 generates scan data by reading from the leading edge to the trailing edge of the printed matter using the line scanners 101 and 102, it is needless to say that the present disclosure is not limited to this, and the following may be performed instead.

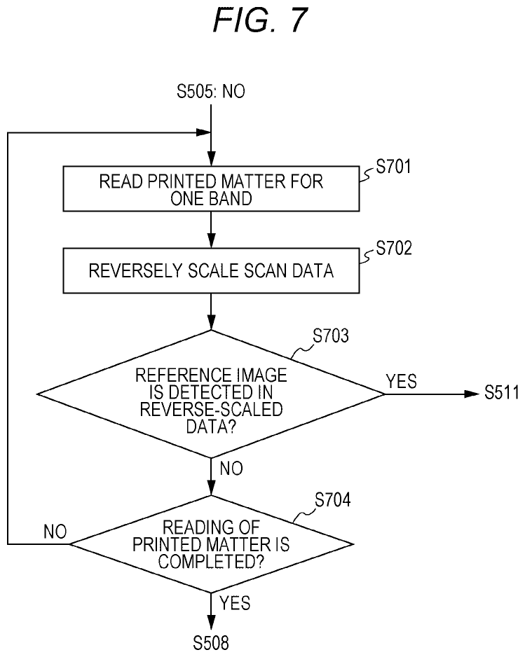

FIG. 7 is a flowchart showing parts that replace the processing of steps S506 and S507 of the flowchart of FIG. 5. As shown in FIG. 7, every time the printed matter is read for one band using the line scanners 101 and 102 (S701), the read scan data for one band may be reversely scaled (S702), and the read image detector 315 may detect whether a reference image is included in the reverse-scaled data for one band. If the reference image is included (S703: YES), the read processing is omitted for the remaining part of the printed matter, and the processing immediately proceeds to step S511.

If the reference image is not included in the reverse-scaled data for one band (S703: NO), it is determined whether or not the one band is the final part. If not, the processing proceeds to step S701, and the above processing is repeated for the following one band. Meanwhile, if the processing is completed for the final part (S704: YES), it is determined that the reference image is not included in the reverse-scaled data of the printed matter, and the processing proceeds to step S508.

Thus, as compared with the case of detecting the reference image after reading the entire printed matter, the throughput of the reference image detection processing can be improved. Accordingly, the productivity of the printer 120 can be improved without being restricted by the processing performance of the reading apparatus 100.

Note that adjacent bands on the printed matter may overlap one another, and in this way, it is possible to prevent decrease in the detection accuracy of the prohibited image due to division of the reference image at the boundary between bands.

(6-2) While the above embodiment describes a case where the recording sheet on which the prohibited image is printed is cut, it goes without saying that the present disclosure is not limited to this, and the following may be performed instead.

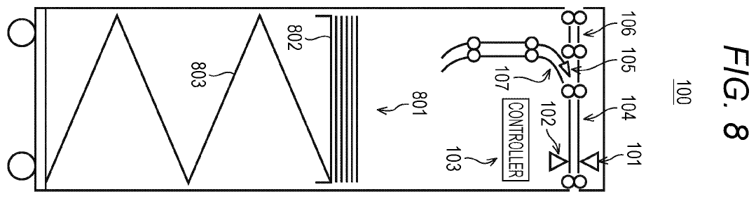

For example, as shown in FIG. 8, by providing a recording sheet container 801 inside a reading apparatus 100, the recording sheet may be stored instead of being cutting. The recording sheet container 801 is provided with a sheet tray 802 for placing recording sheet bundles, and a support member 803 for supporting the sheet tray 802. The support member 803 supports the sheet tray 802 such that the position of the sheet tray 802 becomes lower as the number of recording sheets placed on the sheet tray 802 increases.

Additionally, when an unspecified number of persons access the recording sheet stored in the recording sheet container 801, there is a risk of unauthorized use of the printed matter on which the prohibited image is printed. In order to prohibit such access, the recording sheet container 801 is locked so that a person other than the administrator of the MFP 1 cannot access the recording sheets stored in the recording sheet container 801.

This, too, can prevent unauthorized use of printed matter on which a prohibited image is printed.

(6-3) While the above embodiment describes a case where the reverse scaling processor 314 generates reverse-scaled data by reversely scaling the entire scan data, it goes without saying that the present disclosure is not limited to this, and the following may be performed instead.

For example, the reverse scaling processor 314 may generate reverse-scaled data by reversely scaling only an effective image area of scan data that is an area where the print processor 304 performs printing. Then, the read image detector 315 detects whether or not a reference image is included outside the effective image area of the scan data, in addition to the reverse-scaled data.

Note that the range of the effective image area can be acquired from the edit processor 302, for example. Additionally, the effective image area may be identified with reference to a register included in the scan data. A register is a mark for matching the finished size of printed matter or the finished dimension and the register of multicolored printing, and is also referred to as a register mark or a trim mark.

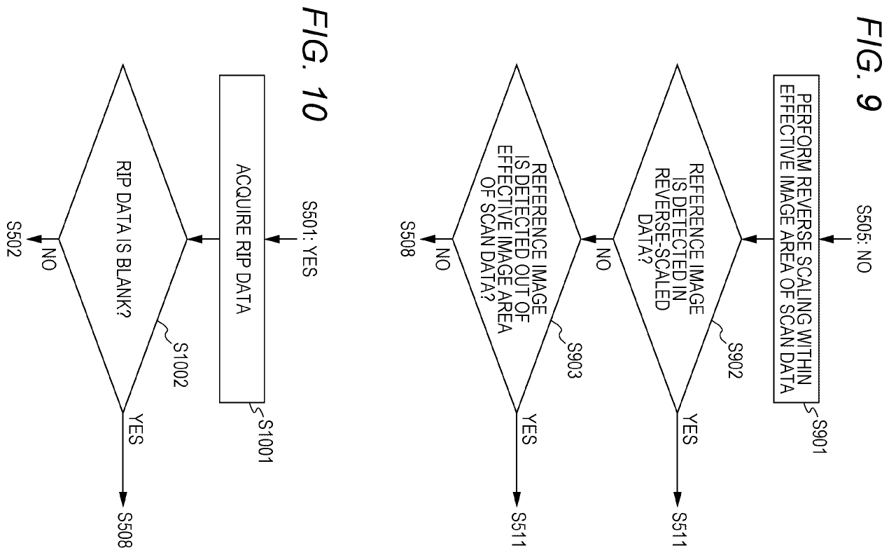

FIG. 9 is a flowchart showing parts that replace the processing of steps S506 and S507 of the flowchart of FIG. 5. As shown in FIG. 9, the reverse scaling processor 314 performs reverse scaling within the effective image area of the scan data to generate reverse-scaled data (S901). If the read image detector 315 detects that the reference image is included in the reverse-scaled data (S902: YES), the processing proceeds to step S511.

Additionally, if the read image detector 315 detects that a reference image is included outside the effective image area of the scan data (S903: YES), the processing proceeds to step S511. If the reference image is not included in reverse-scaled data or outside the effective image area of the scan data, the processing proceeds to step S508.

In this way, when a prohibited image is pasted in an area corresponding to the outside of the effective image area of the recording sheet, the prohibited image can be detected.

(6-4) While the above modification describes a case where the reference image is detected by reverse scaling within the effective image area and one-to-one magnification outside the effective image area, it goes without saying that the present disclosure is not limited to this, and the following may be performed instead.

For example, when RIP data is a blank sheet, the RIP data itself does not include a prohibited image, and therefore it is not necessary to generate reverse-scaled data. If a prohibited image is included in the scan data, that is because the prohibited image is pasted to the recording sheet.

For this reason, when the read controller 103 acquires RIP data from the printer controller 122 and determines whether or not the RIP data is blank and the RIP data is blank, it is only necessary for the read image detector 315 to detect whether or not a reference image is included in the scan data. In this way, it is possible to detect and prevent unauthorized copying that bypasses detection of a prohibited image by the printer controller 122 by pasting the prohibited image on the recording sheet.

FIG. 10 is a flowchart showing processing inserted between steps S501 and S502 in the flowchart of FIG. 5. As shown in FIG. 10, when the read processor 316 reads printed matter (S501: YES), the read controller 103 acquires RIP data from the RIP 301 of the printer controller 122 (S1001), and It is determined whether or not the RIP data is blank.

If the RIP data is not blank (S1002: NO), the processing proceeds to step S502, and the reverse scaling processor 314 acquires a magnification from the edit processor 302. If the RIP data is blank (S1002: YES), the processing proceeds to step S508, and print data is acquired. Note that instead of step S508, the processing may proceed to step S509. However, if there is no problem in print quality, the scan data is also blank, and therefore it is not necessary to detect the reference image by the read image detector 315. Hence, in order to reduce the processing load on the read controller 103, it is effective to proceed to step S508.

In this way, even if unauthorized copying that bypasses detection of a prohibited image by the printer controller 122 is performed, the reference image can be detected, so that such illegality can be prevented.

(6-5) While the above embodiment describes a case where the quality confirmation portion 311 determines whether or not there is a problem with print quality on the basis of whether or not the print data and the scan data match, it goes without saying that the present disclosure is not limited to this, and the print quality may be determined by another method instead of or in addition to this. The present disclosure can provide an effect regardless of the print quality determination method.

(6-6) While the above embodiment describes a case where the line scanners 101 and 102 included in the reading apparatus 100 are color scanners, it goes without saying that the present disclosure is not limited to this, and when printer 120 is a monochrome printer, the line scanners 101 and 102 may also be monochrome scanners. The present disclosure is applicable to this case, too, to obtain its effects.

(6-7) Although not specifically mentioned in the above embodiments, the MFP 1 may perform user authentication before the user starts use, and the log processor 312 of the reading apparatus 100 may acquire the login name of the user may from the printer 120, and enter the login name in the image log. In this way, it becomes easy to identify the user who tried to illegally print the prohibited image, so that it is possible to prevent such unauthorized acts.

(6-8) While the above embodiment does not specifically mention the method by which the log processor 312 stores the image log and the display screen nail image, the image log and the display screen nail image may be stored in the HDD 214, or the read controller 103 may be equipped with a card reading apparatus/writer and the image log and the display screen nail image may be stored in a memory card such as a compact flash (registered trademark) or smart media.

Even when an image log or the like is stored in a storage device that is insertable into the read controller 103, according to the present disclosure, the prohibited image can be efficiently detected, and the scan data including the prohibited image can be detected from the image log or the like. Hence, unauthorized use of prohibited images can be reliably prevented.

(6-9) While the above embodiment describes a case of using the MFP 1 as an example, it goes without saying that the present disclosure is not limited to this, and it may be an MFP having a configuration excluding the scanner 110 and the finisher 140, or the facsimile function may be excluded. Additionally, while the case where the printer 120 is a tandem color printer has been described as an example, the printer 120 may be a color printer other than a tandem printer or a monochrome printer.

As long as the apparatus includes at least the reading apparatus 100, the printer 120, and the sheet feeder 130, the above-described effects can be obtained by applying the present disclosure.

(6-10) While the above embodiment describes a case where a print job is received by the network interface card (NIC) 205 through a communication network such as a local area network (LAN), it may be received by other communication means such as Bluetooth (registered trademark).

The image reading apparatus according to the present disclosure is useful as an apparatus for reducing a processing load for detecting an image for which image formation is prohibited.

Although embodiments of the present disclosure have been described and illustrated in detail, the disclosed embodiments are made for purposes of illustration and example only and not limitation. The scope of the present disclosure should be interpreted by terms of the appended claims.

As used herein, the words “can” and “may” are used in a permissive (i.e., meaning having the potential to), rather than mandatory sense (i.e., meaning must). The words “include,” “includes,” “including,” and the like mean including, but not limited to. Similarly, the singular form of “a” and “the” include plural references unless the context clearly dictates otherwise. And the term “number” shall mean one or an integer greater than one (i.e., a plurality).

What is claimed is:

1. An image reading apparatus comprising:
a scan data acquirer that acquires scan data obtained by reading from printed matter output by an image forming apparatus;
a magnification acquirer that acquires a magnification used when the printed matter is imaged;
a reverse scaling part that generates reverse-scaled data obtained by scaling the scan data at a reverse magnification that is the reciprocal of the magnification acquired by the magnification acquirer; and
a determiner that determines whether a predetermined reference image is included in the reverse-scaled data by comparing with the predetermined reference image.

2. The image reading apparatus according to claim 1, further comprising:
a discard part that discards the scan data and the reverse-scaled data when the determination result of the determiner is affirmative.

3. The image reading apparatus according to claim 1, further comprising:
an output prohibitor that prohibits output of the printed matter to the outside of the apparatus when the determination result of the determiner is affirmative,
wherein the magnification acquired by the magnification acquirer is a magnification within a predetermined range including one-to-one magnification.

4. The image reading apparatus according to claim 1, wherein the image forming apparatus includes a print data generator that generates print data by scaling raster image processor (RIP) data and a print data determiner that determines whether the predetermined reference image is included in the print data,
wherein the image reading apparatus further comprises a determination result acquirer that acquires a determination result by the print data determiner from the image forming apparatus, and
wherein the output prohibitor also prohibits output of the printed matter to the outside of the apparatus when the determination result acquired by the determination result acquirer is affirmative and the magnification acquired by the magnification acquirer is within a predetermined range including one-to-one magnification.

5. The image reading apparatus according to claim 4, further comprising:
a determination prohibitor that prohibits the determination by the determiner when the magnification acquired by the magnification acquirer is one-to-one magnification.

6. The image reading apparatus according to claim 3, wherein the prohibitor prohibits the output by processing the printed matter to be unusable.

7. The image reading apparatus according to claim 1, further comprising:
an effective image area identifier that identifies an effective image area in the scan data;
a determination controller that causes the determiner to make the determination only in the effective image area in the scan data; and
an out-of-effective image area determiner that determines whether a predetermined reference image is included in scan data before scaling by the reverse scaling part, for the outside of the effective image area in the scan data.

8. The image reading apparatus according to claim 1, wherein the scan data is divided into a plurality of detection bands for each page,
wherein the reverse scaling part scales the scan data in units of detection bands whose recording by the scan data acquirer is completed, and
wherein the determiner makes the determination in units of the detection bands.

9. The image reading apparatus according to claim 1, further comprising:
a quality confirmation part that confirms the quality of the scan data in units of pages when the determination result by the determiner is negative.

10. The image reading apparatus according to claim 1, further comprising:
a blank sheet determiner that determines whether RIP data for imaging the printed matter is a blank sheet; and
a slip-through determiner that determines whether the predetermined reference image is included in the scan data when the determination result of the blank sheet determiner is affirmative.

11. The image reading apparatus according to claim 1, wherein the predetermined reference image is a reference image of one-to-one magnification.

12. The image reading apparatus according to claim 1, wherein the reference image includes a feature pattern having a predetermined feature.

13. The image reading apparatus according to claim 1, wherein the magnification acquired by the magnification acquirer is a magnification specified in a print job.

14. The image reading apparatus according to claim 1, wherein the magnification acquirer acquires the magnification from the image forming apparatus.

15. The image reading apparatus according to claim 13, wherein the print job is a job received by the image forming apparatus from another apparatus.

16. The image reading apparatus according to claim 15, wherein the image forming apparatus receives the job from the other apparatus through a communication network.
